(19) United States
(12) Patent Application Publication
(10) Pub. No.: US 2025/0103007 A1
(43) Pub. Date: Mar. 27, 2025

(54) WATCH ROTATING STRUCTURE

(71) Applicant: AIOLOS SOLUTIONS LIMITED, HongKong (CN)

(72) Inventor: CALVIN ANTHONY MACKENZIE, HongKong (CN)

(21) Appl. No.: 18/664,540

(22) Filed: May 15, 2024

(30) Foreign Application Priority Data
Sep. 26, 2023 (CN) 202322617789.2

(51) Int. Cl. G04B 27/00

(52) U.S. Cl. CPC G04B 27/001; G04B 27/002

(57) ABSTRACT

A watch rotating structure is provided, relates to a technical field of watches, including a dial, a bottom of the dial is activity connected with a bottom shell, the bottom of the dial is further provided with a driving gear disk, and the driving gear disk is constrained on the bottom shell, and an upper part of the bottom shell is provided with a driving gear set, and the driving gear set is activity connected to the bottom shell through a connecting shaft and is meshed with the driving gear disk. Through the watch rotating structure to adjust the dial to rotate, the watch can still be adjusted from the outside after the exchange of wearing hands, and the dial is still displayed forward, which not only increases the fun of use, but also enhances the use experience.

### CROSS REFERENCE TO RELATED APPLICATIONS

This application claims foreign priority of Chinese Patent Application No. 202322617789. 2, filed on Sep. 26, 2023 in the China National Intellectual Property Administration, the disclosures of all of which are hereby incorporated by reference.

### TECHNICAL FIELD

The present disclosure relates to the technical field of watch rotating structure, in particular to the technical field of watch.

### BACKGROUND

The watch is commonly used in people's daily life to remind the time, and can also be used as an ornament to meet the needs of different users.

The existed watch structure with rotating structure, its adjusting knob is usually only positioned on one side, particularly on the right side. When the watch is worn in the left hand, it can be conveniently adjusted the adjusting knob with the right hand, and when the watch is worn in the right hand, then the left hand cannot adjust the adjusting knob conveniently, and it needs to be worn after adjustment. Which brings poor use experience to the user. And if the right hand wears the watch needs to be directly and conveniently adjusted the adjusting knob as well, then the watch needs to be worn in the opposite direction, and the whole dial is displayed in the opposite direction. And it can not meet the wearing needs of different users, needs to purchase a watch that conforms to the wearing habit to use, and can not use the same watch to meet the needs of different wearing modes.

### SUMMARY

The purpose of the present application is to provide a watch rotating structure that is configured to be worn in reverse with both hands in view of the defects or deficiencies in the prior art. Through the watch rotating structure to adjust the dial to rotate, the adjusting knob of the watch can still be adjusted from the outside after the exchange of wearing hands, and the dial is still displayed forward, which not only increases the fun of use, but also further enhances the use experience of different wearers.

In order to achieve the above purpose, the application adopts the following technical solutions, including a dial (1), a bottom of the dial (1) is activity connected with a bottom shell (2), the bottom of the dial (1) is further provided with a driving gear disk (3), and the driving gear disk (3) is constrained on the bottom shell (2), and an upper part of the bottom shell (2) is provided with a driving gear set (4), and the driving gear set (4) is activity connected to the bottom shell (2) through a connecting shaft (40) and is meshed with the driving gear disk (3).

In another embodiment, the bottom shell (2) is provided with a driving knob (5) on the side, a front end of the driving knob (5) is provided with a driving gear (8) meshed with the driving gear disk (3).

In another embodiment, the driving gear set (4) includes a sign steering gear (4-1), a transmission gear (4-2) and a driven gear (4-3), and the sign steering gear (4-1), the transmission gear (4-2) and the driven gear (4-3) are gears with bearings in a center, and are arranged on the bottom shell (2) through a connecting shaft, where, the transmission gear (4-2) is meshed with the driving gear disk (3), and the driven gear (4-3) is meshed with the transmission gear (4-2) and the sign steering gear (4-1).

In another embodiment, a number of teeth of the transmission gear (4-2) and a number of the driven gear (4-3) are the same, and a number of teeth and a diameter of the sign steering gear (4-1) are greater than that of the transmission gear (4-2) and the driven gear (4-3).

In another embodiment, the driving knob (5) is provided with a knob shaft (9), which runs through the bottom shell (2) and connects with the driving gear (8).

In another embodiment, an upper surface of the bottom shell (2) is a sunken platform structure, and a depth of the sinking surface is matched with a thickness of the driving gear disk (3).

In another embodiment, a middle of the bottom shell (2) is provided with a fixed shaft (2-1), the fixed shaft (2-1) runs through the dial (1) and connects with a pointer (1-1) in the dial (1), and a part of the fixed shaft that runs through the dial (1) is connected with the bearing, the bearing is in a center of the dial (1).

In another embodiment, the side of the bottom shell (2) is also defined with a gear groove (2-2) matched with the driving gear (8).

In another embodiment, the sign steering gear (4-1) is provided with a sign (7), and the initial position of the sign (7) is a position of twelve o'clock.

In another embodiment, the side of the bottom shell (2) is also provided with a pointer adjusting knob (6), and an adjusting shaft of the pointer adjusting knob (6) extends to an interior of the bottom shell (2) and is connected with a movement.

After adopting the above technical solutions, the beneficial effects of this application include: through the watch rotating structure to adjust the dial to rotate, the watch can still be adjusted from the outside after the exchange of wearing hands, and the dial is still displayed forward, which not only increases the fun of use, but also enhances the use experience of different wearers.

### BRIEF DESCRIPTION OF THE DRAWINGS

In order to illustrate the technical solutions in the embodiments of this application or the prior art more clearly, the drawings that need to be used in the embodiments or prior art descriptions will be briefly introduced below, obviously, the drawings in the following description are only some embodiments of the application, and for ordinary skilled personnel in the field, under the premise of skipping paying creative labor, other drawings can also be obtained according to these drawings.

FIG. 1 is a schematic structure diagram of a watch rotating structure according an embodiment of the present disclosure;

FIG. 2 is a schematic structure diagram of the watch rotating structure with a bottom shell 2 removed from FIG. 1;

FIG. 3 is a schematic diagram of a matching state of the driving gear disk 3, a driving gear set 4 and a driving gear 8;

FIG. 4 is an exploded diagram of the watch rotating structure according an embodiment of the present disclosure;

FIG. 5 is another schematic structure diagram of the watch rotating structure according an embodiment of the present disclosure.

FIG. 6 is a schematic diagram of the driving gear set and a connecting shaft.

The appended drawing reference signs: a dial 1, a bottom shell 2, a driving gear disk 3, a driving gear set 4, a driving knob 5, a pointer adjusting knob 6, a sign 7, a driving gear 8, a knob shaft 9, pointers 1-1, a fixed shaft 2-1, a gear groove 2-2, a sign steering gear 4-1, a transmission gear 4-2, a driven gear 4-3, a connecting shaft 40, a adjusting shaft 6-1.

### DESCRIPTION OF THE EMBODIMENTS

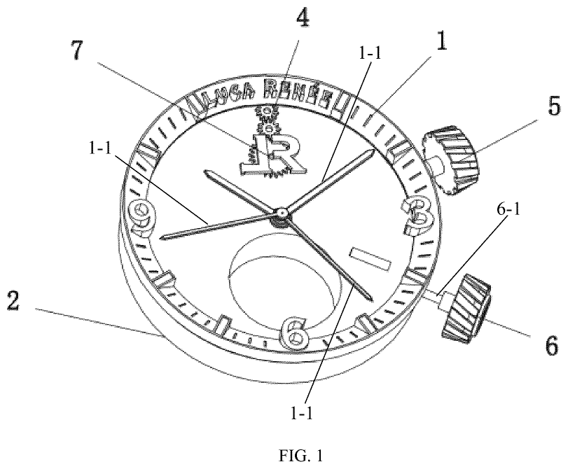

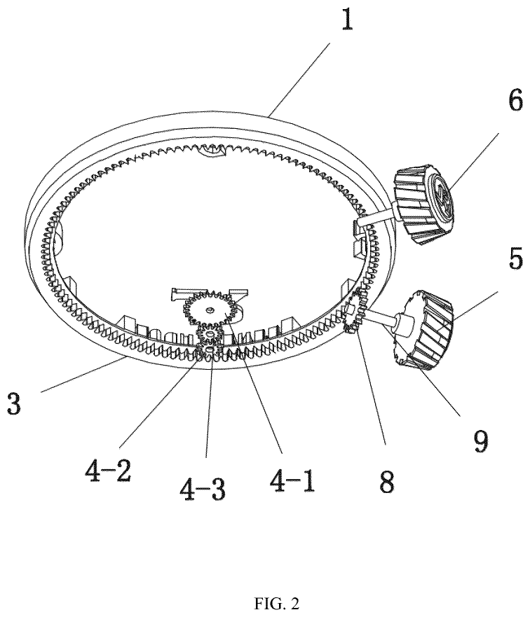

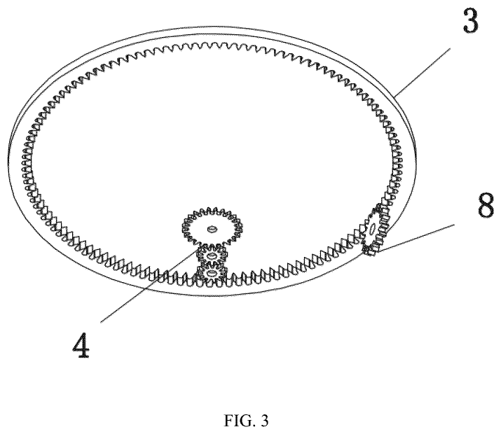

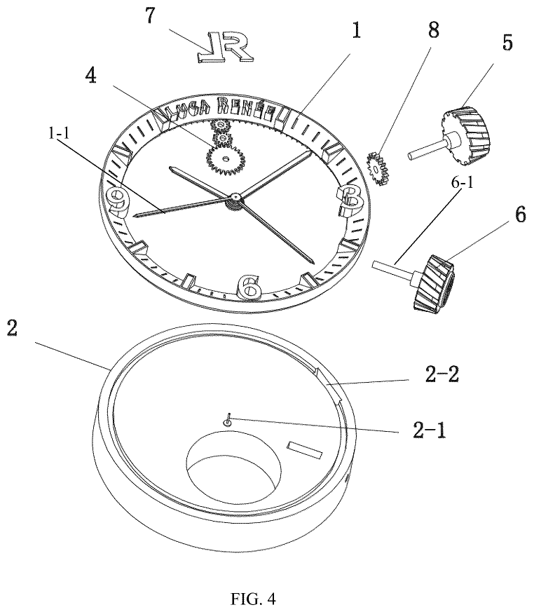

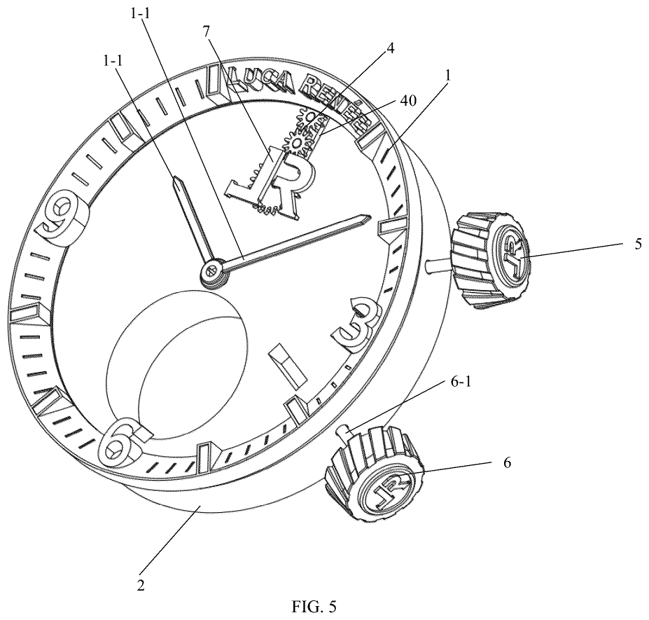

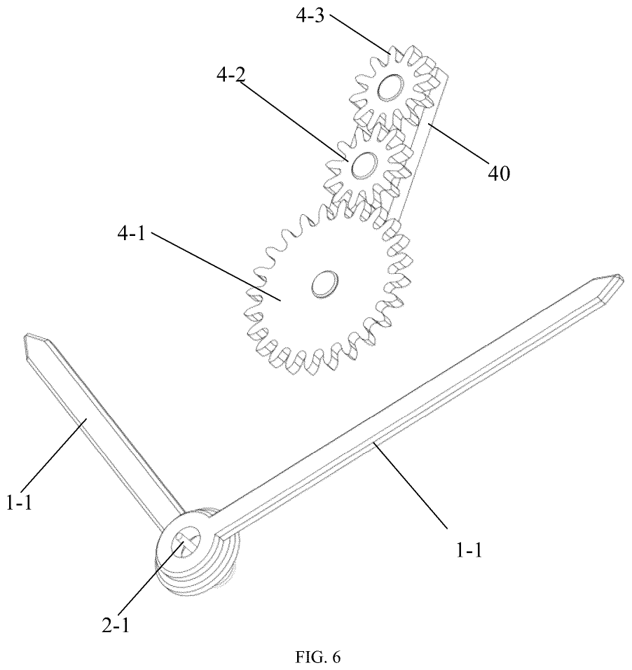

As shown in FIG. 1-6, the technical solutions adopted in this embodiment are as follows:

The watch rotating structure includes a dial (1), a bottom of the dial (1) is activity connected with a bottom shell (2), the bottom of the dial (1) is further provided with a driving gear disk (3), and the driving gear disk (3) is constrained on the bottom shell (2), and an upper part of the bottom shell (2) is provided with a driving gear set (4), and the driving gear set (4) is activity connected to the bottom shell (2) through a connecting shaft (40) and is meshed with the driving gear disk (3). In the existed watch structure, the pointer adjusting knob is usually located on one side, taking the right side as an example, when worn in the left hand, the adjusting knob is located on the right side, and the right hand can conveniently adjust and use from the outside; but when the user is accustomed to wearing with the right hand, the adjusting knob is no longer on the outside, the left hand can not adjust and use from the outside. There is inconvenient adjustment situation, in order to facilitate the adjustment and use, it is usually adjusting before wearing. Herein, a rotatable dial structure is provided, and the dial and the driving gear disk are connected and formed fixed structures. The driving gear disk can carry out circumferential rotation under the drive of the driving gear assemble. When the watch wearing hand is changed, the watch as a whole is turned over 180 degrees, and the driving gear disk is driven to rotate. In this embodiment, the bottom shell (2) is provided with a driving knob (5) on the side, a front end of the driving knob (5) is provided with a driving gear (8) meshed with the driving gear disk (3). After the watch flip wearing, the driving knob is on the outside, and the rotation adjustment makes the driving gear driving the whole drive gear disk to rotate, until the driving gear disk also rotates 180 degrees or rotates to the user's habitual viewing position, so that no matter which hand the watch is on, the driving knob of the watch can be adjusted from the outside and used, which greatly improves user experience.

In another embodiment, the driving gear set (4) includes a sign steering gear (4-1), a transmission gear (4-2) and a driven gear (4-3), and the sign steering gear (4-1), the transmission gear (4-2) and the driven gear (4-3) are gears with bearings in a center, and are arranged on the bottom shell (2) through a connecting shaft (40). Where, the transmission gear (4-2) is meshed with the driving gear disk (3), and the driven gear (4-3) is meshed with the transmission gear (4-2) and the sign steering gear (4-1), and a number of teeth of the transmission gear (4-2) and a number of the driven gear (4-3) are the same, and a number of teeth and a diameter of the sign steering gear (4-1) are greater than that of the transmission gear (4-2) and the driven gear (4-3). In this embodiment, the driving gear set (4) adopts three gears, where the transmission gear (4-2) is matched with the driving gear disk (3), and the driven gear (4-3) is rotated under the drive of the driving gear disk (3), and the rotating of the driven gear (4-3) drives the sign steering gear (4-1) to rotate;

Since the sign steering gear (4-1) is provided with a sign (7), and a initial position of the sign (7) is a position of twelve o'clock. When changing the wearing hand, the sign can also be flipped in the direction, so when rotating the dial, the sign (7) is driven to rotate synchronously. So that the sign (7) also rotates the same angle after the dial completes rotation, only the upper and lower position changes to ensure that the sign (7) is still in in a forward position, to provide a better visual experience.

More specifically, the driving knob (5) is provided with a knob shaft (9), which runs through the bottom shell (2) and connects with the driving gear (8). In this embodiment, the driving knob (5) drives the rotation of the driving gear (8) through the connection between a knob shaft (9) and the driving gear (8), to carry out the rotation adjustment of the dial (1). In another embodiment, the driving gear (8) and the driving knob (5) are canceled, and the dial (1) is directly rotated to drive the rotation of the sign (7), which helps reduce the production cost. It can be selected according to productions and use demands, and there is no restriction in this disclosure.

More specifically, the upper surface of the bottom shell (2) is a sunken platform structure, and the depth of the sunken platform structure is matched with a thickness of the driving gear disk (3), the installation position of the driving gear disk (3) is formed by setting up the sunken platform structure, and the driving gear disk (3) is constrained. It should be noted that, in this embodiment, a shell, a face cover and other structures of the watch are not shown, and the limit of the dial is matched with the face cover through the shell.

More specifically, a middle of the bottom shell (2) is provided with a fixed shaft (2-1), the fixed shaft (2-1) runs through the dial (1) and connects with pointers (1-1) in the dial (1), and a part of the fixed shaft that runs through the dial (1) is connected with the bearing in the center of the dial (1).

More specifically, the side of the bottom shell (2) is also provided with a gear groove (2-2) matched with the driving gear (8), the gear groove is the mounting groove of the driving gear (8), and also is the movable groove of the driving gear (8), when the driving gear and the driving knob (5) are not adopted, the gear groove (2-2) is also canceled correspondingly

Furthermore, the side of the bottom shell (2) is also provided with a pointer adjusting knob (6), and an adjusting shaft (6-1) of the pointer adjusting knob (6) extends to an interior of the bottom shell (2) and is connected with a movement.

The working principle of this application: the dial (1) and the driving gear disk 3 are connecting structures, the driving gear disk (3) and the dial (1) are in a synchronous rotation relationship. The driving gear disk (3) is meshed with the transmission gear 4-2 in the driving gear set (4). When rotating the driving knob (5), the driving gear (8) drives the driving gear disk (3) to rotate, and the driving gear disk (3) rotates synchronously with the dial (1), and drives the transmission gear (4-2) to rotate simultaneously, and the transmission gear (4-2) drives the driven gear 4-3 to rotate, and then the driven gear (4-3) drives the sign steering gear (4-1) to rotate. Since the sign (7) is fixed on the sign steering gear (4-1), and driven by the sign steering gear (4-1), when the dial (1) turns 180 degrees, the sign (7) also turns 180 degrees, when the users changes the watch from the left hand to right hand, the dial (1) and the sign (7) are turned at the same time, while the pointer adjusting knob (6) is still located on the outside position, and takes convenient for the wearers.

The above is only used to illustrate the technical solutions of the application and not intend to restrict, and other modifications or equivalent substitutions made by ordinary technical personnel in the field to the technical solutions of the application, as long as they skip deviating from the design ideas and scope of the technical solutions of the application, shall be covered within the scope of the claims of the application.

1. a watch rotating structure, wherein, comprising a dial, a bottom of the dial is activity connected with a bottom shell;
the bottom of the dial is further provided with a driving gear disk, and the driving gear disk is constrained on the bottom shell;
an upper part of the bottom shell is provided with a driving gear set;
the driving gear set is activity connected to the bottom shell through a connecting shaft and is meshed with the driving gear disk.

2. The watch rotating structure according to claim 1, wherein, the bottom shell is provided with a driving knob on the side, a front end of the driving knob is provided with a driving gear, and the driving gear is meshed with the driving gear disk.

3. The watch rotating structure according to claim 1, wherein, the driving gear set comprises a sign steering gear, a transmission gear and a driven gear;
where, the sign steering gear, the transmission gear and the driven gear are gears with bearings in a center, and
the sign steering gear, the transmission gear and the driven gear are arranged on the bottom shell through a connecting shaft, where, the transmission gear is meshed with the driving gear disk, and the driven gear is meshed with the transmission gear and the sign steering gear.

4. The watch rotating structure according to claim 3, wherein, a number of teeth of the transmission gear and a number of the driven gear are the same, and a number of teeth and a diameter of the sign steering gear are greater than that of the transmission gear and the driven gear.

5. The watch rotating structure according to claim 2, wherein, the driving knob is provided with a knob shaft, and the knob shaft runs through the bottom shell and connects with the driving gear.

6. The watch rotating structure according to claim 1, wherein, an upper surface of the bottom shell is a sunken platform structure, and a depth of the sunken platform structure is matched with a thickness of the driving gear disk.

7. The watch rotating structure according to claim 1, wherein, a middle of the bottom shell is provided with a fixed shaft, the fixed shaft runs through the dial and connects with pointers in the dial, and a part of the fixed shaft that runs through the dial is connected with a bearing, the bearing is in a center of the dial.

8. The watch rotating structure according to claim 1, wherein, an inner side of the bottom shell is also defined with a gear groove, and the gear groove is matched with the driving gear.

9. The watch rotating structure according to claim 3, wherein, the sign steering gear is provided with a sign, and an initial position of the sign is a position of twelve o'clock.

10. The watch rotating structure according to claim 1, wherein, a side of the bottom shell is also provided with a pointer adjusting knob, and an adjusting shaft of the pointer adjusting knob extends to an interior of the bottom shell and is connected with a movement.
